(19) United States
(12) Patent Application Publication
(10) Pub. No.: US 2005/0119950 A1
(43) Pub. Date: Jun. 2, 2005

(54) Method and system for warehouse and supply chain management

(76) Inventor: Derek Anderson, Eldersburg, MD (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/958,271

(22) Filed: Oct. 6, 2004

Related U.S. Application Data
(60) Provisional application No. 60/508,283, filed on Oct. 6, 2003.

(51) Int. Cl. G06F 17/60

(52) U.S. Cl. 705/28

(57) ABSTRACT

The present invention includes a method and system for interactively viewing, tracking, and managing stored inventory, for example, in centralized off-site locations, such as warehouses and shipping/receiving centers. The present invention allows the user to view and track every segment of the shipping history of a product stored in several warehouses, as well as delivery to a final recipient. In one embodiment, identifying information specifying an inventory item is stored in a database, and the identifying information is associated with an inventory listing and a responsible party Once inventory information has been stored, a user can access various features for managing inventory. These features include modifying an inventory item, viewing the history of a shipping order, to generating reports, accessing administrative information, or accessing help information.

This application claims priority to applicants' copending U.S. Provisional Application Ser. No. 60/508,283 titled “METHOD AND SYSTEM FOR WAREHOUSE AND SUPPLY CHAIN MANAGEMENT” filed Oct. 6, 2003. The entirety of that patent application is incorporated herein by reference.

### BACKGROUND OF THE INVENTION

1. Field of the Invention

The present invention relates to a method and system for accessing and managing warehouse and supply chain information.

2. Background of the Technology

The warehousing, shipping and inventory management industries typically handle large quantities of inventory or other items on a daily basis. These industries are responsible for moving and tracking inventory as it is stored, relocated, or moved between geographical locations. In managing inventory, these industries are responsible for knowing the whereabouts of the inventory at all times, and ensuring that the various agents or parties responsible for the inventory efficiently coordinate to complete their assigned tasks.

Handling large quantities of inventory is a complex task. The likelihood of misplacing or losing inventory increases as the volume of the inventory increases. Thus, developing a method of managing the inventory is of importance.

There remains an unmet need for a method and system for managing warehouse and supply chain inventory in an efficient, comprehensive, responsive, and cost-effective manner.

### SUMMARY OF THE INVENTION

The present invention includes a method and system for interactively viewing, tracking, and managing stored inventory, for example, in centralized off-site locations, such as warehouses and shipping/receiving centers. The present invention allows the user to view and track every segment of the shipping history of a product stored in several warehouses, as well as delivery to a final recipient. Among other advantages, the present invention greatly reduces the time necessary for retrieving shipping and identity information from non-automated sources and therefore ensures that inventory is properly tracked and delivered.

In one embodiment of the invention, a method for electronically tracking inventory includes receiving identifying information specifying an inventory item and identifying at least one inventory listing associated with the inventory item. The method further includes identifying at least one responsible party associated with the inventory item and storing the identifying information in a data repository.

Once inventory information has been stored, a user can access various features for managing inventory. These features include, for example, modifying an inventory item, viewing the history of a shipping order, generating reports, accessing administrative information, or accessing help information.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the Drawings:

FIG. 1 presents a representative diagram of various system components in accordance with an embodiment of the present invention;

FIG. 2 presents an example flow diagram of functions performed for inputting an inventory record, in accordance with an embodiment of the present invention;

FIGS. 3a and 3b present an organization and structure chart of a method and system for warehouse and supply chain management, in accordance with an embodiment of the present invention;

FIGS. 4a-4d present flow diagrams of processes for viewing, modifying, and creating inventory records, viewing, modifying, and creating shipping/work order records, viewing, modifying, and creating reports, viewing, modifying, and creating administrative records and obtaining help, in accordance with an embodiment of the present invention;

FIG. 5 presents hardware, software or a combination thereof that may be implemented in one or more computer systems or other processing systems to carry out the functionality of the present invention; and

FIGS. 6-31 present exemplary Graphical User Interface (GUI) screens, in accordance with an embodiment of the present invention.

### DETAILED DESCRIPTION

Among other advantages, the present invention provides methods and systems to allow a user to view, edit, modify, and otherwise manage inventory information. In one embodiment of the present invention, the user may initiate a new inventory list or view previously entered inventory lists by selecting the appropriate menu option. In one embodiment of the present invention, the user initially creates a list of assets (referred to interchangeably herein as “inventory”) itemized, categorized, or grouped as selected by the user (herein referred to generally as “inventory listing”), which is to be stored in the repository. In one embodiment, the user then selects the appropriate form for creating and inputting a record of each item of the inventory. The user then chooses a party, to which the inventory belongs (also referred to herein as the “inventory owner”), from a list of inventory owners, along with other inventory-specific information, such as project, location, assignment, or work order.

To add information or to create a new inventory item, the user enters identifying characteristics for each inventory item. In one variation, the identifying characteristics include a general description of the inventory, current location status, identification tags specific to each item, such as bar codes, which are usually in the form of electronic numeric or alpha-numeric listings, and a general description of quantity, size, department, and other identifying characteristics adequately identifying the inventory.

In addition, digital images of each inventory item are created and included in the repository, in one embodiment of the present invention. For example, in one variation, a digital camera is used to generate a digital image, which is then coded with an identifier, such as a serial number, bar code, or client number. The digital image is then saved in the repository and assigned the corresponding owner/client number.

In one variation of the present invention, the identifying characteristics of the inventory are manually entered by the user using a narrative format or, for example using pre-drafted text selected from a series of choices displayed in a drop down menu, provided by radio buttons, or selectable in conjunction with other methods of presenting multiple choices known in the art. In another variation of the present invention, the identifying characteristics of the inventory are scanned or are electronically recognized (e.g., using optical character recognition (OCR)), for example, and automatically stored in the appropriate data fields.

In another embodiment of the present invention, the user modifies an existing inventory list that was previously created. In this embodiment, the user accesses a category of inventory listed under the inventory listing by, for example, clicking or otherwise selecting an inventory category. The GUI retrieves a corresponding itemized list of inventory, which is provided graphically in a chart, table, or other sortable listing (referred to interchangeably herein as “listing”). The user is able to select an item, for example, by clicking on the graphical representation of the item or a corresponding link, such as a hyperlink, using the mouse cursor. In one embodiment, selection of an inventory item links the user to an editable page in which the user can modify inventory information, or links the user to a follow-up screen providing additional information, such as detailed identifying characteristics. The user edits the identifying characteristics at the user's discretion or according to a standard convention. Modifications are automatically saved, or alternatively, modifications are saved upon an affirmative action by the user, such as clicking on the appropriate button (e.g., the “save” button).

The user may also view the warehouse and supply chain history with regard to the inventory listed by company, by product, by manufacturer, or by a similar type category. For example, the user can follow the warehouse and shipping history of any one inventory item recorded using the present invention. In one embodiment, to obtain history information, the user chooses an option to view work orders, for example, and either selects the appropriate category or inventory listing, or simply queries the system for a specific inventory item. In one embodiment of the present invention, on each screen of the GUI, the user may query the system to find relevant information by searching relevant search terms.

After selecting the appropriate inventory listing, the user selects one of the topics, such as customer name, inventory owner name, project, work order, or similar type groupings, associated with the inventory listing. This selection produces an itemized list of inventory corresponding to the subject matter of the topic. In one variation, the itemized table organizes and displays all inputted identifying characteristics associated with each inventory item. In another variation, additional information regarding the inventory item is accessed by selecting a corresponding link, such as a hyperlink, providing further detail regarding the inventory. Identifying characteristics include, for example, work order status, location of inventory, authorizing party, project name, destination, specific instructions, customer number, date completed or cancelled, and modification/work history.

In an embodiment of the present invention, each inventory item contains a detailed shipping/warehousing/storage history, which is made up of portions referred to in one embodiment as “work orders.” Each work order contains information regarding the events and people involved with the inventory, such as information on sending and receiving the inventory item, parties authorizing the sending and receiving of the inventory item, parties retrieving, sending, and delivering the inventory item, order status, and other identifying characteristics of the inventory item.

In one embodiment of the present invention, the user is able to create a shipping order. The user selects an item of inventory stored on the system. The system then directs the user to subsequent GUI screens that allow the user to input details pertaining to the work order, such as, shipping/delivery address, responsible parties, dates, quantity, priority, as well as other relevant information. Once the user enters the details, the system registers the information and updates the system accordingly. The user is provided with a code or identifying name, such as an alphanumeric name, to identify the work order and retrieve information regarding the order using the system of the present invention.

In yet another embodiment of the present invention, the GUI provides a data sorting function that produces analyses, also known interchangeably herein as “reports,” based on data recorded in the software. Reports are developed and generated by analyzing the relationship between any two identifying characteristics. Reports include, for example, work orders by customer, work orders by site, inventory totals by customer, inventory totals by date, and exception reports. In one variation of the present invention, the reports are generated in a database or spreadsheet format, such as spreadsheets generated in Excel, which is manufactured by Microsoft Corporation of Seattle, Wash. Reports are also downloadable and printable, in one embodiment of the invention.

Administrative level aspects of the present invention allow establishment of permission-based users, locations for a particular owner or relevant to a work order, and a listing of projects, which may be sorted, for example, by owner. In an embodiment of the present invention, only users having administrative privileges access the appropriate portion of the software to input administrative information.

In addition, an embodiment of the present invention includes a help function that provides additional resources to the user to assist the user in navigating the GUI. Features of the help function include such topics as query abilities, frequently asked questions, content guides, and other similar resources.

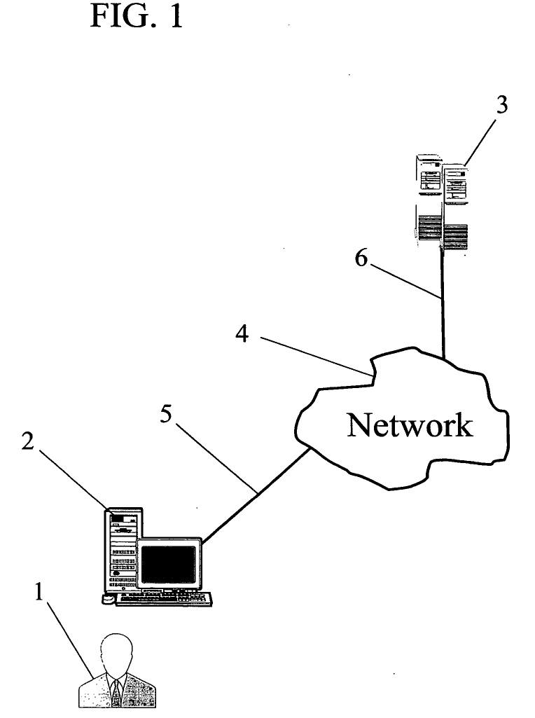

As shown in FIG. 1, in one embodiment of the present invention, a user, such as an employee of a warehousing company, shipping company, or other inventory management company, accesses warehouse and supply chain information. The user 1 is, for example, a customer, consumer, owner of the assets, warehouse employee, shipping employee, bailee, or inventory clerk (referred to interchangeably herein as a “responsible party”). The user 1 accesses warehouse and supply chain information via a terminal 2, such as a personal computer (PC), minicomputer, mainframe computer, microcomputer, personal digital assistant (PDA), telephone device or other device having a processor, display, and input capability. The terminal 2 provides methods and systems for communication, including electronic media, allowing input by the user 1. In one variation, the user accesses information using the terminal 2 via a network 4, such as the Internet, a Local Area Network (LAN), or a Wide Area Network (WAN). As further shown in FIG. 1, in one embodiment, the user 1 accesses a server 3, such as a PC, minicomputer, mainframe computer, microcomputer, or other device having a processor and a repository for data or connection to a repository for maintained data, via the network 4 and couplings 5, 6, such as wired, wireless, or fiber optic connections.

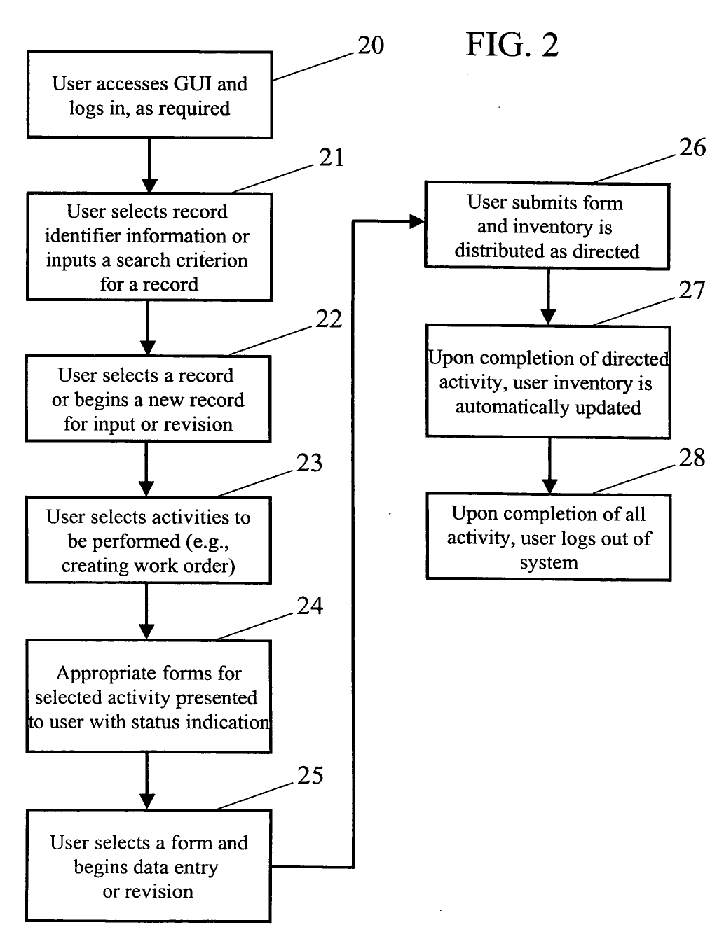

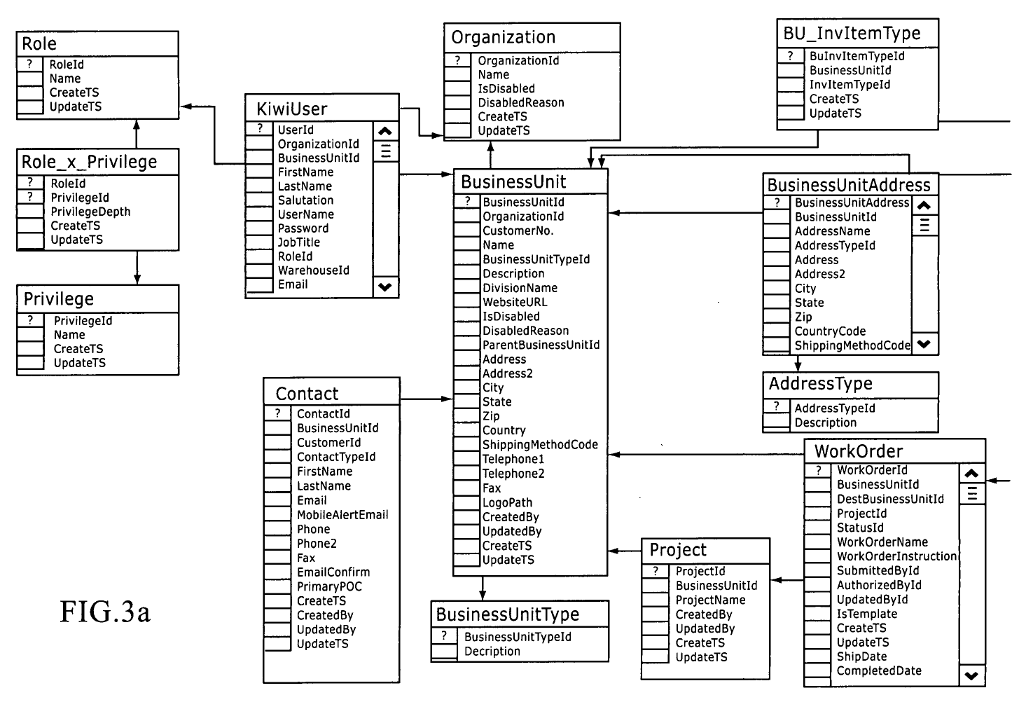

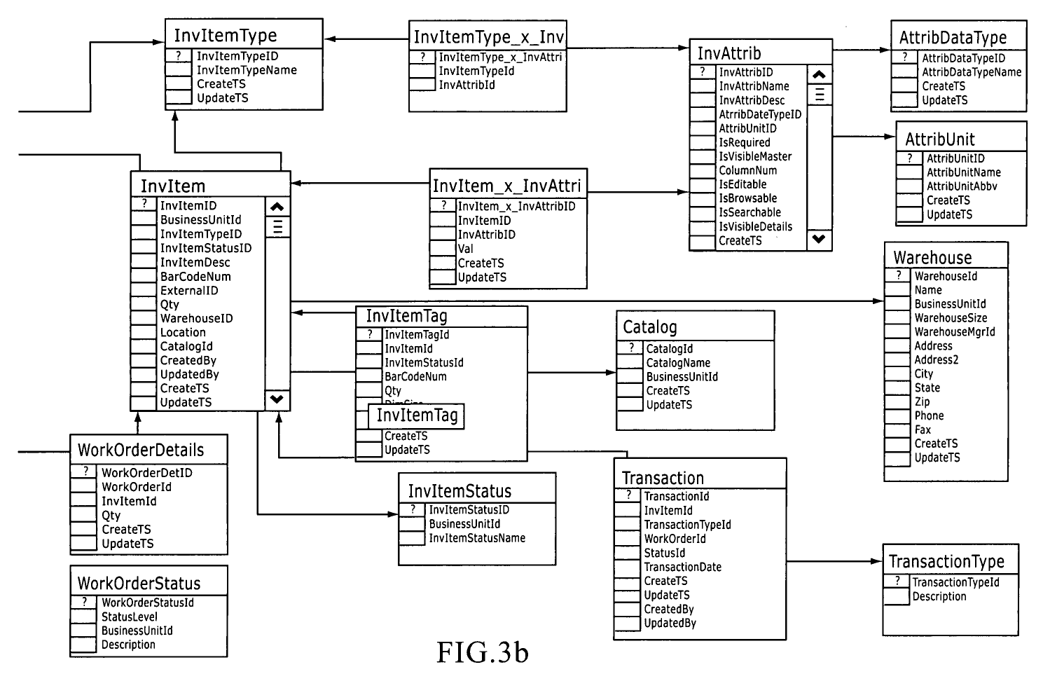

In an embodiment of the present invention, as shown in FIGS. 2, 3a, and 3b, the user utilizes a graphical user interface (GUI) to view, update, modify, track, or otherwise manage warehouse and supply chain information. In one variation of the present invention, inventory and order information, such as shipping work orders, is displayed via the GUI, allowing the user to perform a variety of functions, such as tracking inventory, viewing inventory, modifying inventory, and creating work orders, inventory totals, and exception reports.

As shown in FIG. 2, the user generally accesses the GUI and logs on 20. The user then selects record identifier information or inputs a search criterion for a record 21. The record identifier information or search criterion identifies one or more records, which are displayed to the user. The user selects a record, or alternatively initiates a new record 22. The user selects an activity to be performed, such as, creating a work order 23. In step 24, the appropriate form or forms for the activity are generated and presented to the user. In step 25, the user selects one or more forms and completes the forms, such as, by populating data fields and/or by revising data. The user then submits the form or forms in step 26, and the activity is completed as specified in the form or forms. Completing the activity includes, for example, distributing inventory as specified in the form or forms. In step 27, the user activity is registered by the system and user information is automatically updated. Upon completion of activity, the user exits the system 28.

Example user activity in accordance with embodiments of the present invention will now be described in greater detail. In one embodiment of the present invention, prior to access of data and use of forms, the user logs into the system (e.g., provides a recognized user name and a password) or otherwise meets security requirements. In one variation of the present invention, the user's security information is processed by software or the server using a network connection, such as the Internet, a WAN, or a LAN prior to access of a repository, such as an electronic database. In one variation of the present invention, the network confirms access to the user but variably provides authority to either modify, view/read, or save according to predetermined privileges granted to the user and associated with user's security identification. This feature is generally known in the art as “permission-based” use. For instance, a user predetermined to have read-only rights is identified by the system and prevented from modifying data.

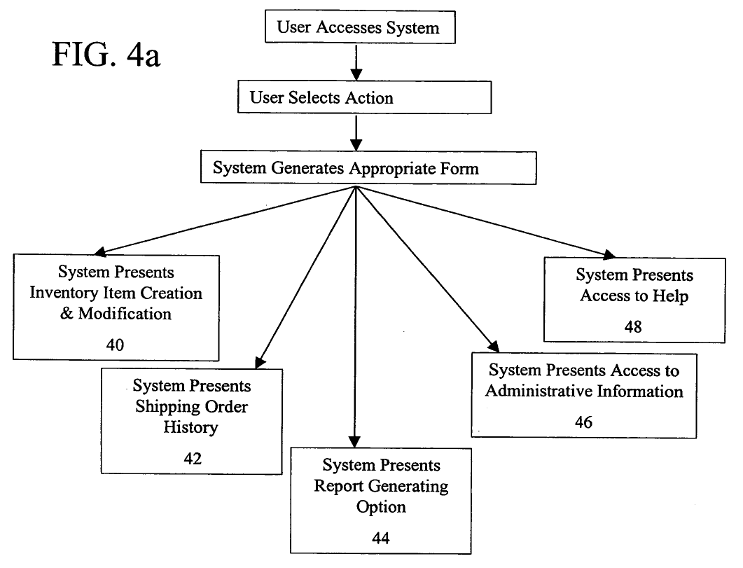

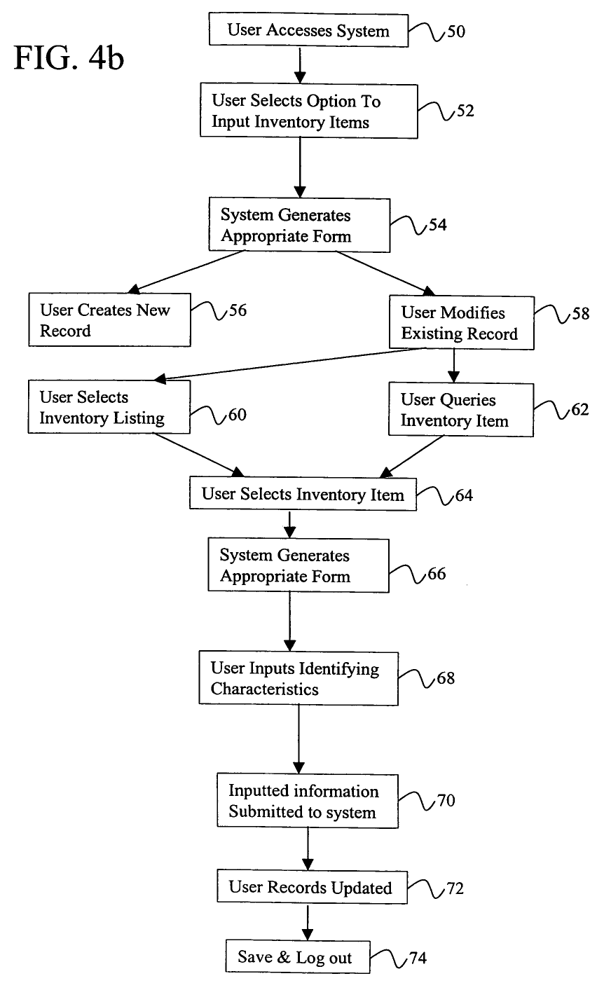

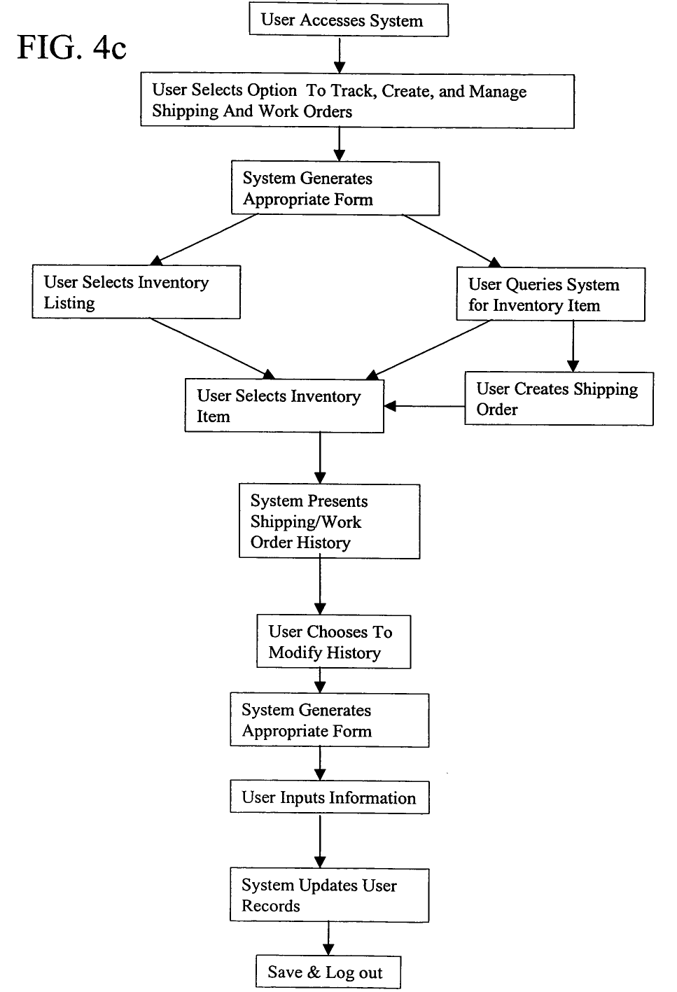

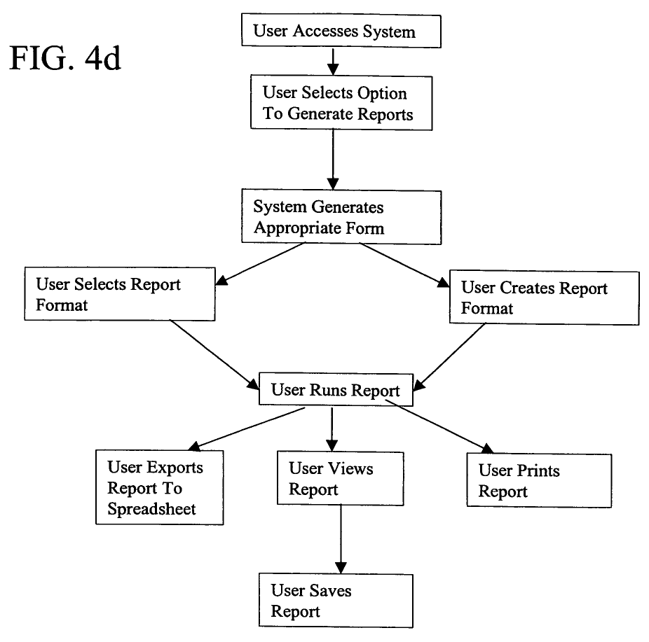

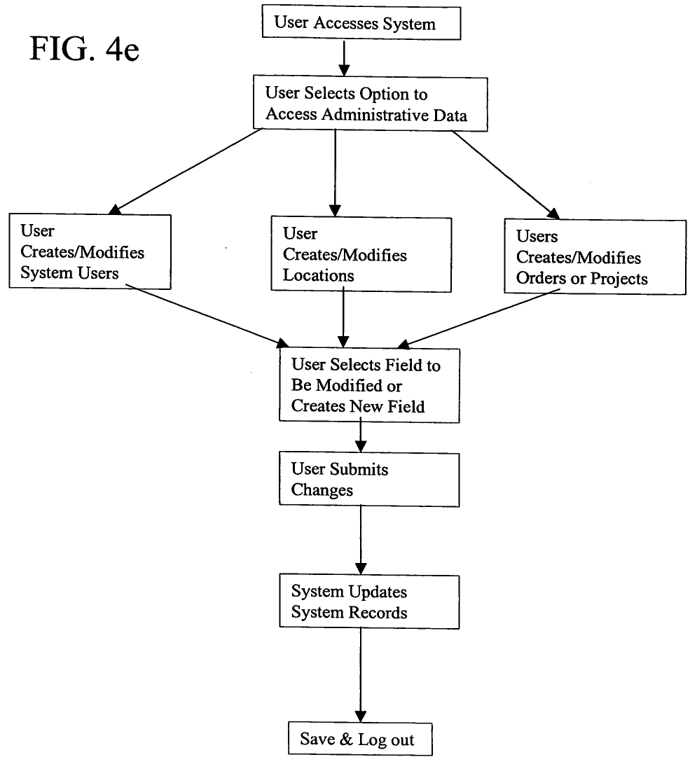

Once the user is provided access to the software, the user, depending on the user's level of permission, can input, view, track, or otherwise manage data and perform other functions. User functions in one embodiment of the present invention are graphically shown in FIGS. 4a-4e. The user may perform, for example, the following functions: 1) creating, modifying or viewing records of inventory items; 2) creating, modifying, or viewing records of shipping data, which includes work orders and deliveries; 3) generating and viewing summary reports of any record; 4) accessing and modifying administrative information; and 5) accessing an interactive help system to guide the user through the GUI.

As shown in FIG. 4a, once a form has been generated, the user has access to a number of functions relating to the form. The user may choose to create or modify an inventory item 40, to view a shipping order history 42, to generate a report 44, to access administrative information 46, or to access help information 48.

As shown in FIG. 4b, a user first logs into the system 50, and selects the option to input inventory 52 from a list of activity options. The system then generates one or more forms 54, and the user may select to create a new record 56, or to modify an existing record 58. In creating a new record, the user enters one or more new inventory items and other identifying information, such as owner, shipping address, and the like. In modifying an existing inventory list previously created 58, the user accesses a category of inventory listed under the inventory listing by, for example, clicking or otherwise selecting an inventory category. The GUI retrieves a corresponding itemized list of inventory, which is provided graphically in a chart, table, or other sortable listing (referred to interchangeably herein as “listing”). The user is able to select an item 60, for example, by clicking on the graphical representation of the item or a corresponding link, such as a hyperlink, using the mouse cursor. Alternatively, the user may choose to query the inventory system 62 in order to retrieve the appropriate inventory item.

A form for modifying the inventory item is then provided 64. In one embodiment, selection of an inventory item generates the form and links the user to an editable page in which the user can modify inventory information, or links the user to a follow-up screen providing additional information, such as detailed identifying characteristics. The user edits the identifying characteristics or otherwise inputs identifying characteristics 68 at the user's discretion or according to a standard convention. The information is submitted to the system 70, user records are updated 72, and modifications are automatically saved 74. Alternatively, modifications are saved upon an affirmative action by the user, such as clicking on the appropriate button (e.g., the “save” button).

FIG. 4c is a flowchart illustrating a method for tracking, creating, and managing shipping and work orders, in accordance with an aspect of the present invention. As shown in FIG. 4c, a user begins by accessing a system and selecting an option to track, create, and manage shipping and work orders from a list of available activities. The system generates the appropriate form, and the user chooses to select an inventory listing, and subsequently to select an inventory item from a list of inventory items in the inventory listing. Alternatively, the user queries the system to find the inventory item, optionally creates a shipping order, and selects the inventory item.

The system then presents the user with the shipping/work order history. The user chooses to modify the history and is presented with the appropriate form. The user inputs or modifies information, and the system updates the user records. The changes are saved and the user logs out.

FIG. 4d is a flowchart illustrating a method for generating reports, in accordance with an aspect of the present invention. As shown in FIG. 4d, a user begins by accessing a system and selecting an option to generate reports from a list of available activities. The system generates the appropriate form, and the user chooses to select a report format, or alternatively, to create a new report format. The user then runs the specified report, and may choose to export the report to a spreadsheet, to view the report, or to print the report. The user may also choose to save the report.

FIG. 4e is a flowchart illustrating a method for accessing administrative data, in accordance with an aspect of the present invention. As shown in FIG. 4e, an administrative user begins by accessing a system and selecting an option to access administrative data from a list of available activities. The administrative user chooses to create a new system user or modify system user information (e.g., change user privileges), to create or modify a location, or to create or modify an order or project. The administrative user then selects a field to be modified or creates a new field. The administrative user submits the changes, the system updates the records and saves the changes, and the user logs out.

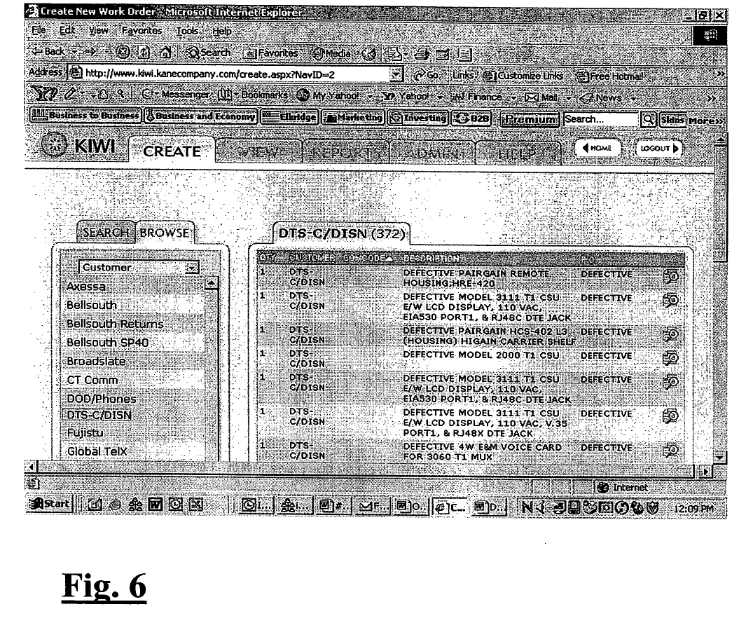

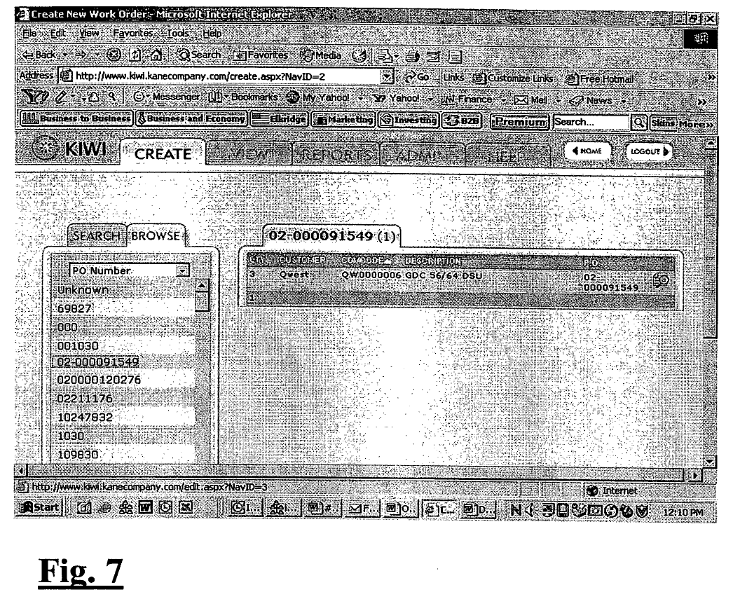

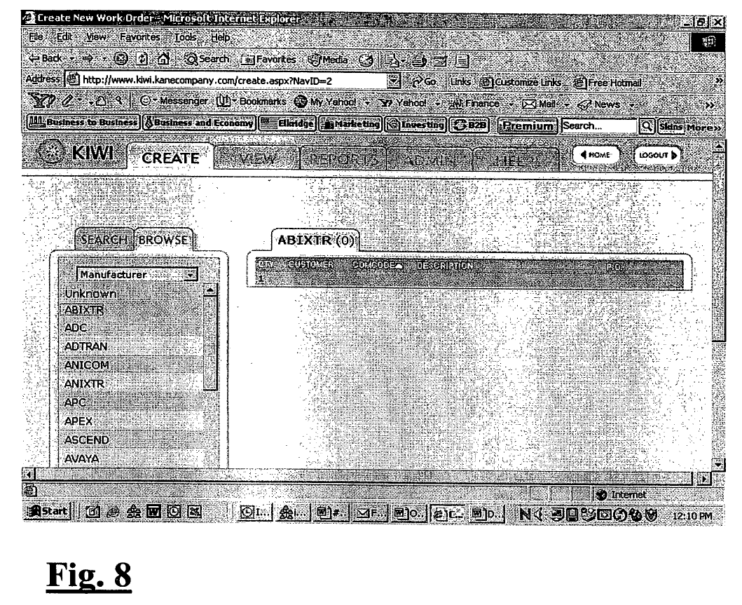

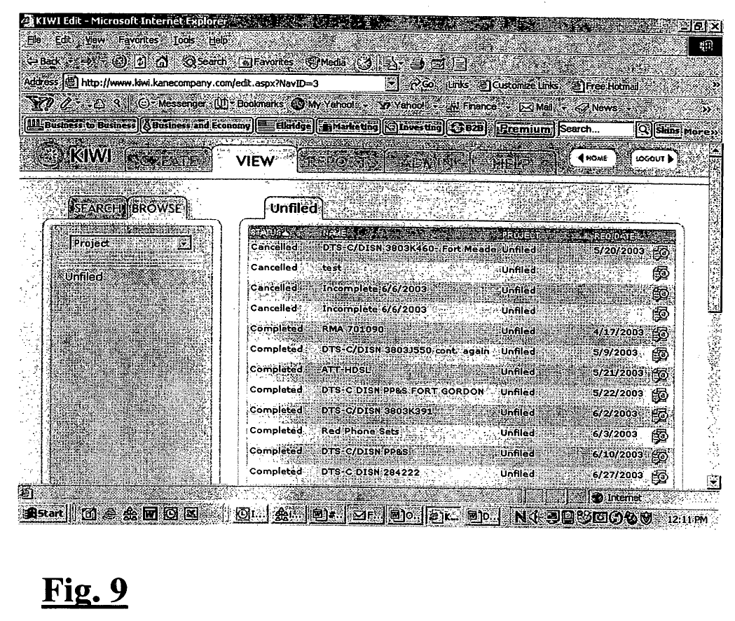

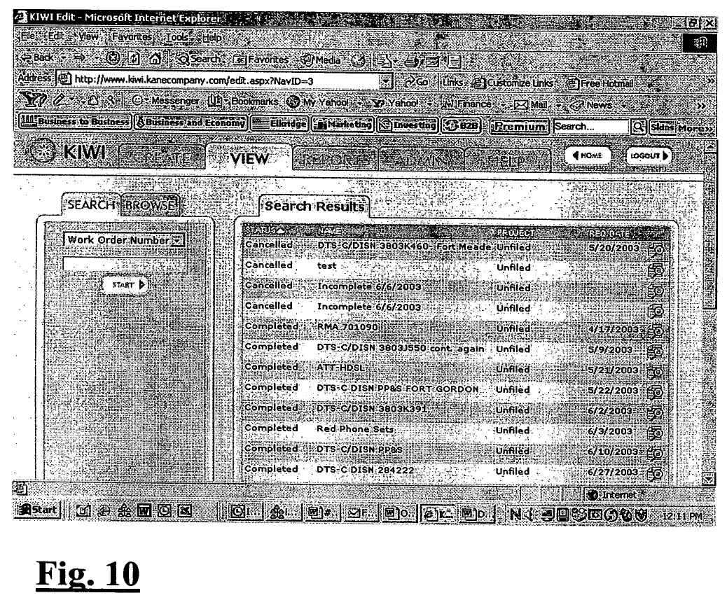

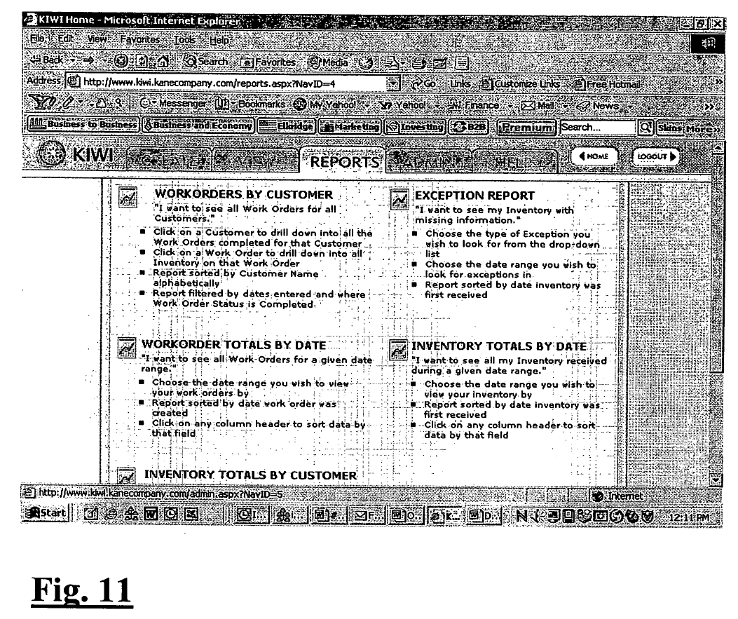

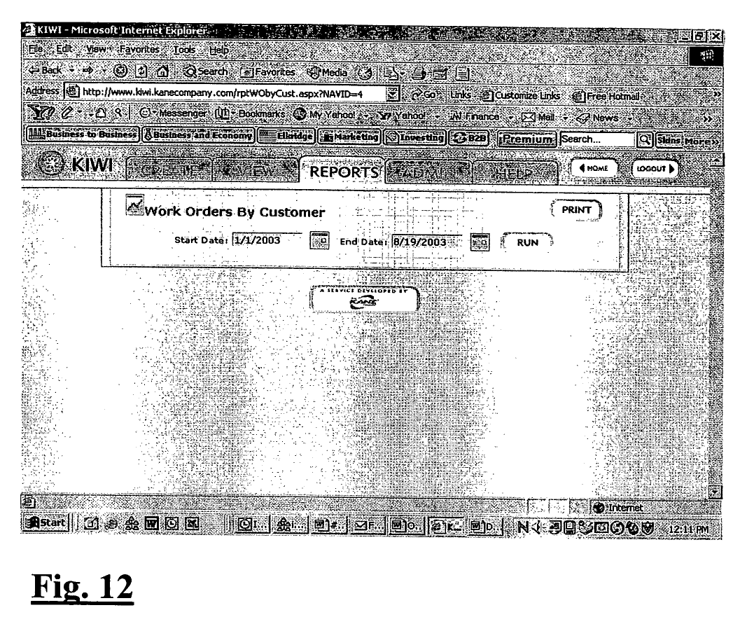

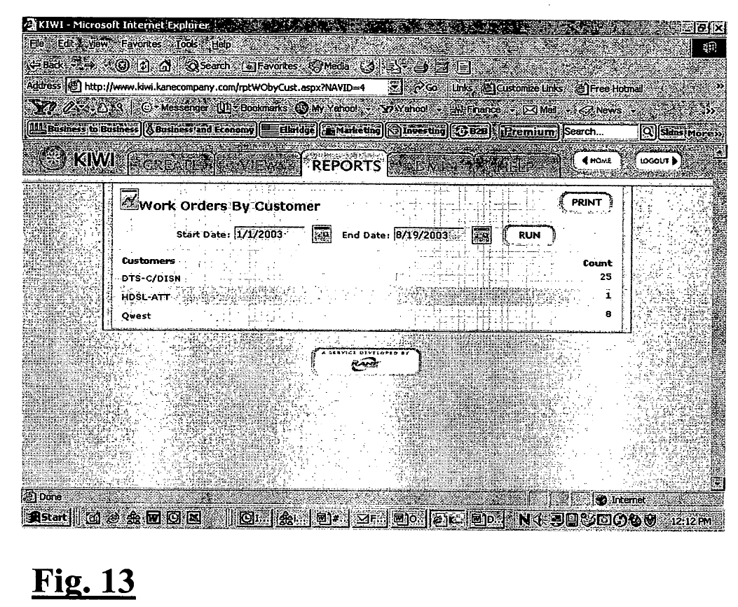

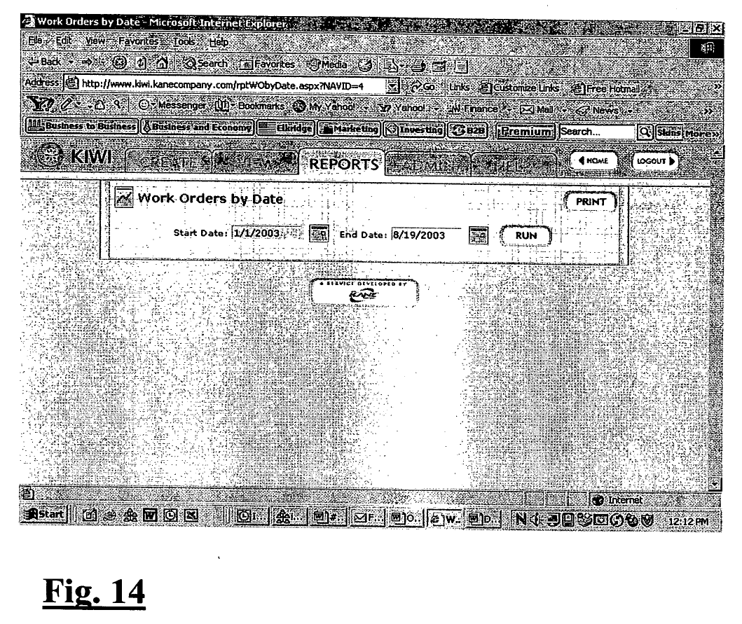

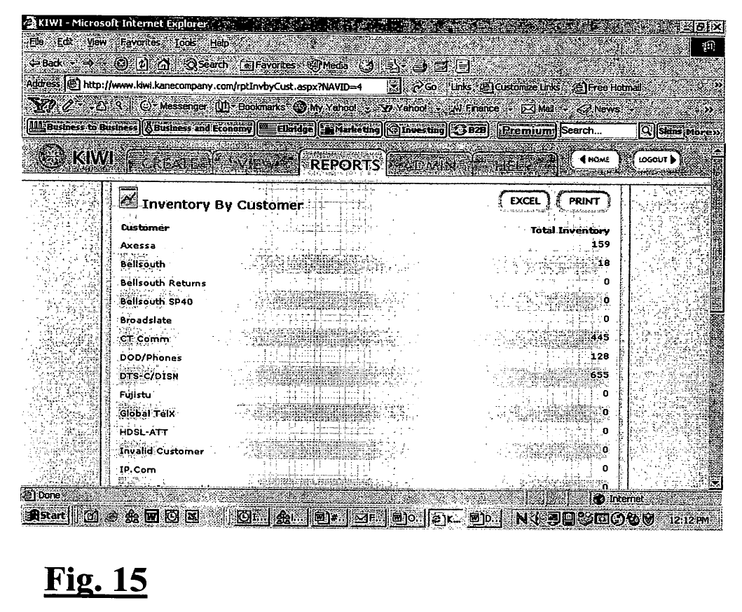

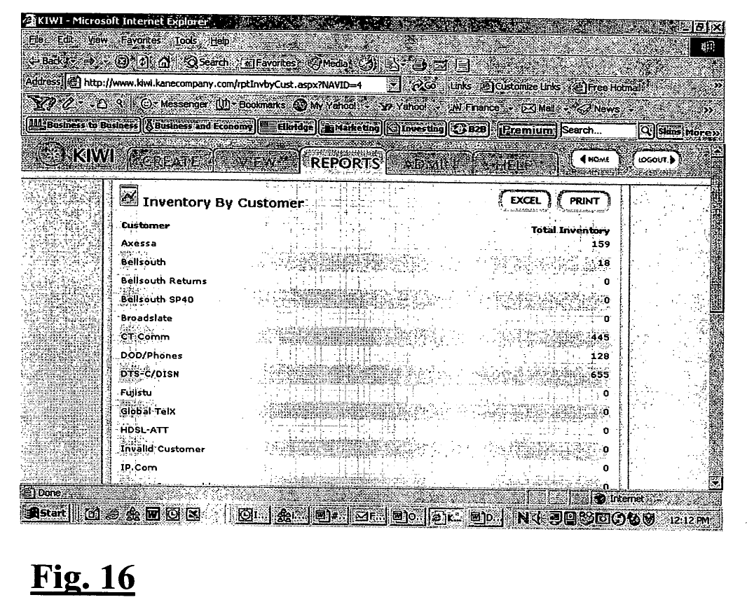

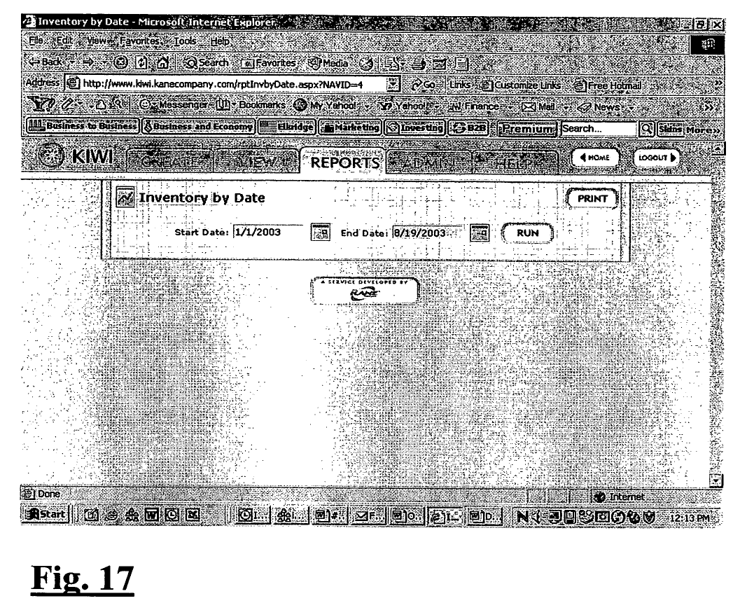

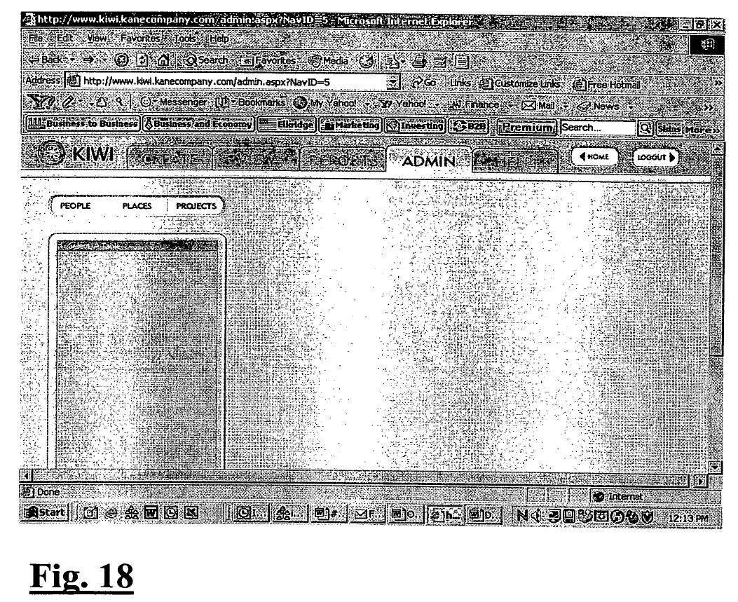

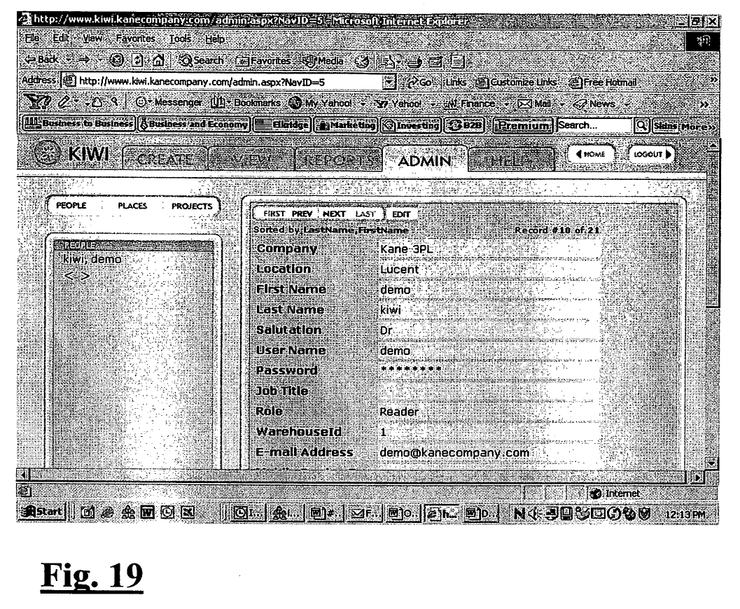

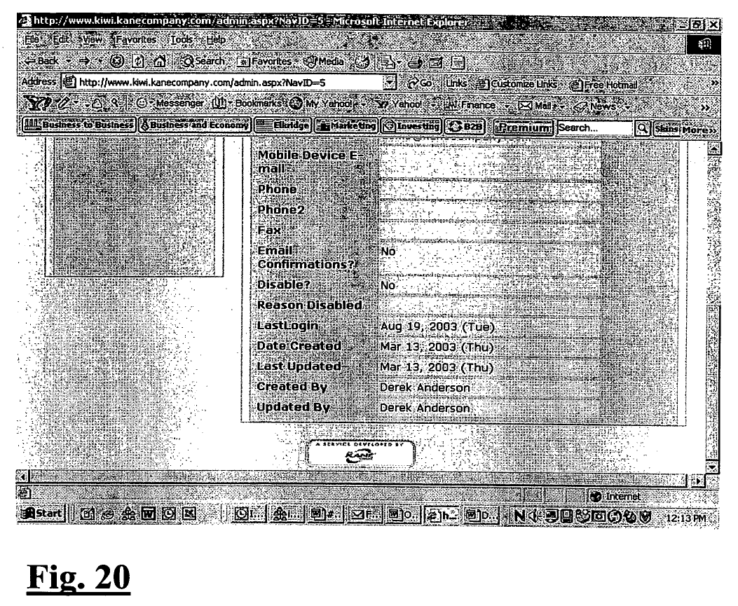

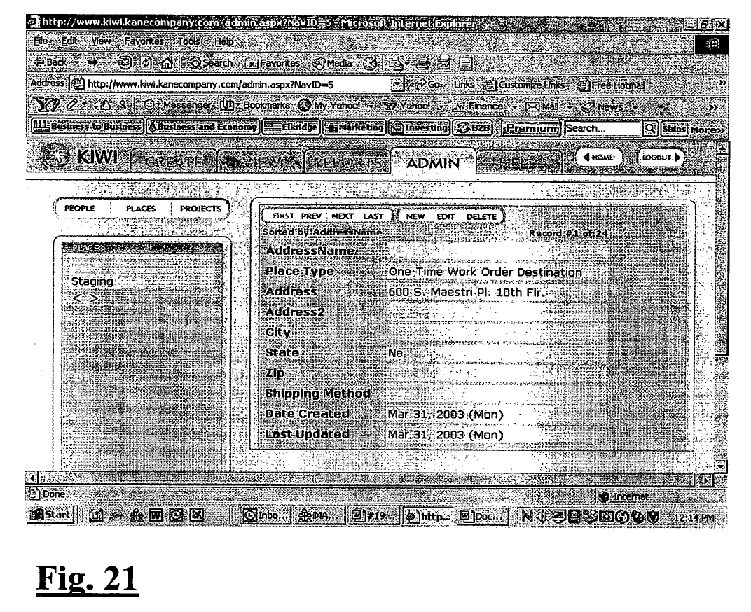

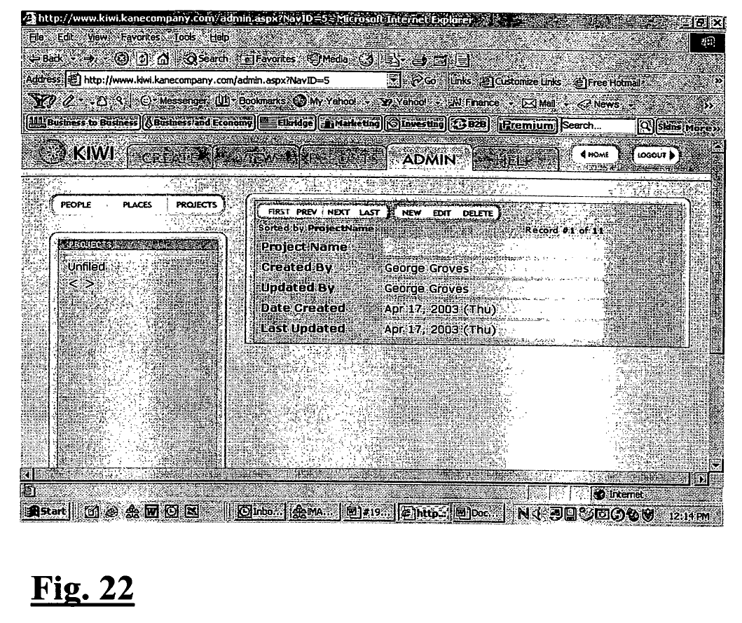

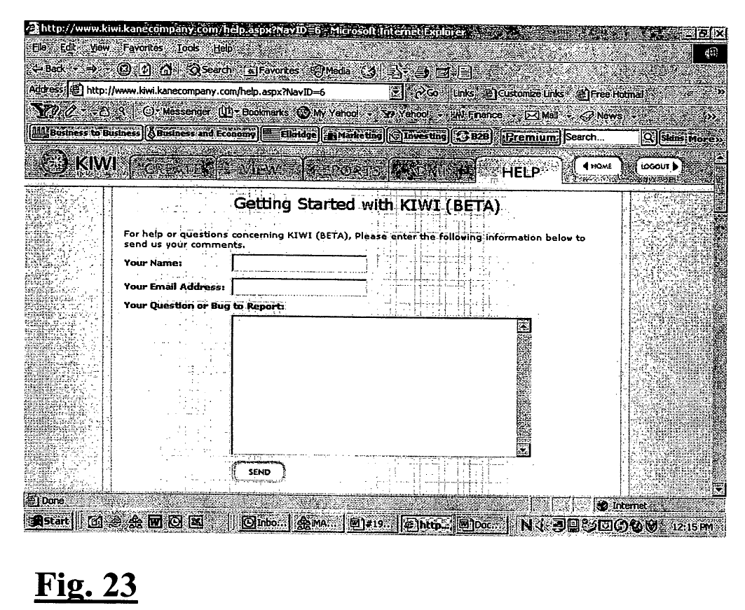

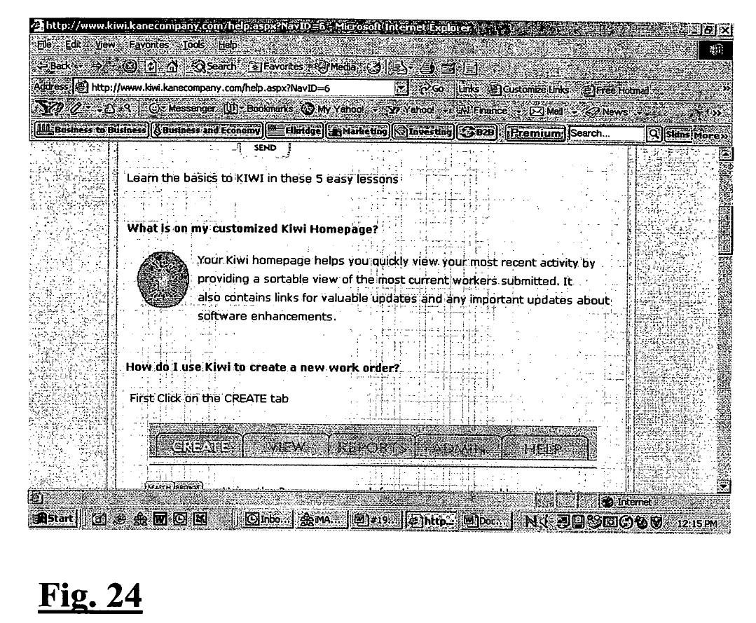

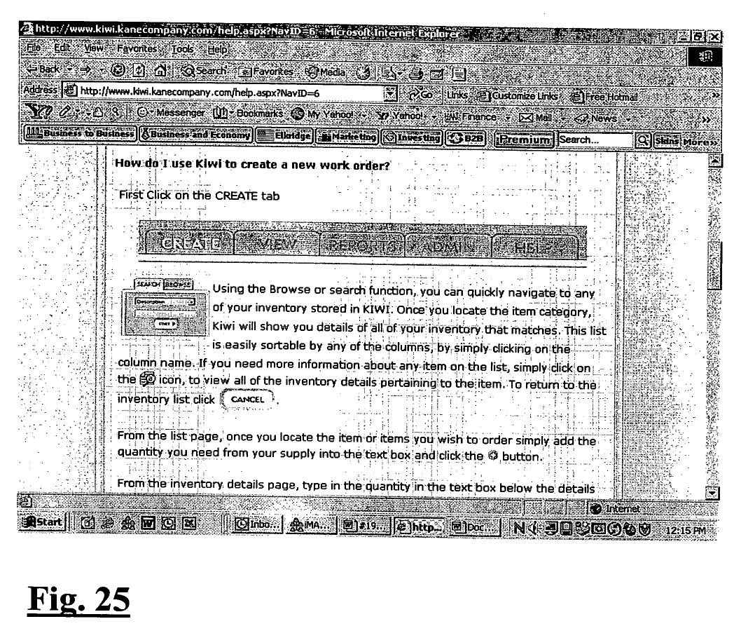

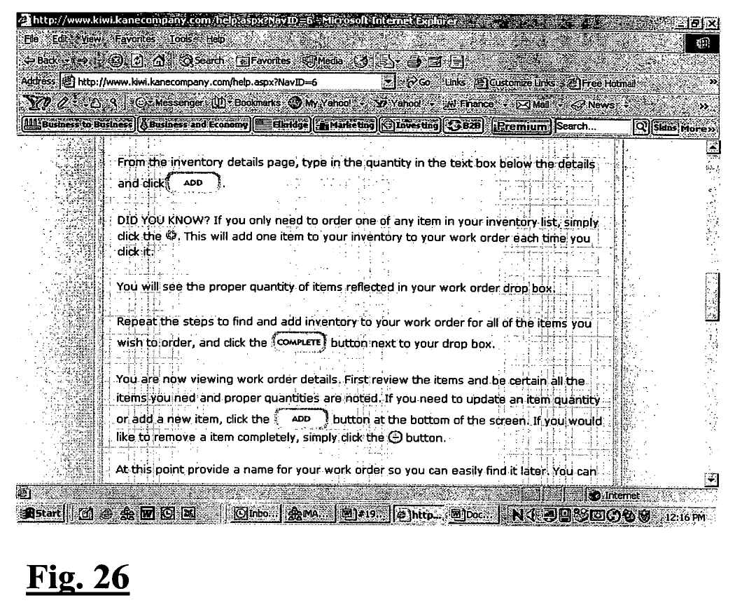

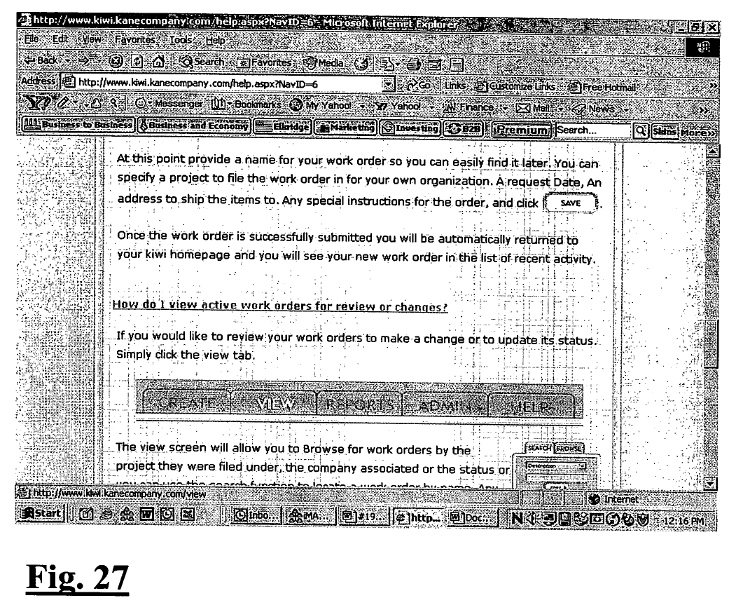

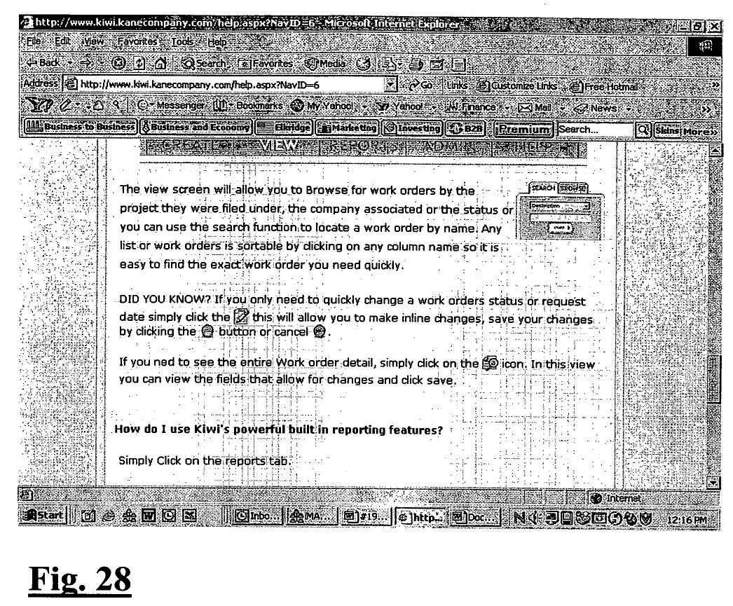

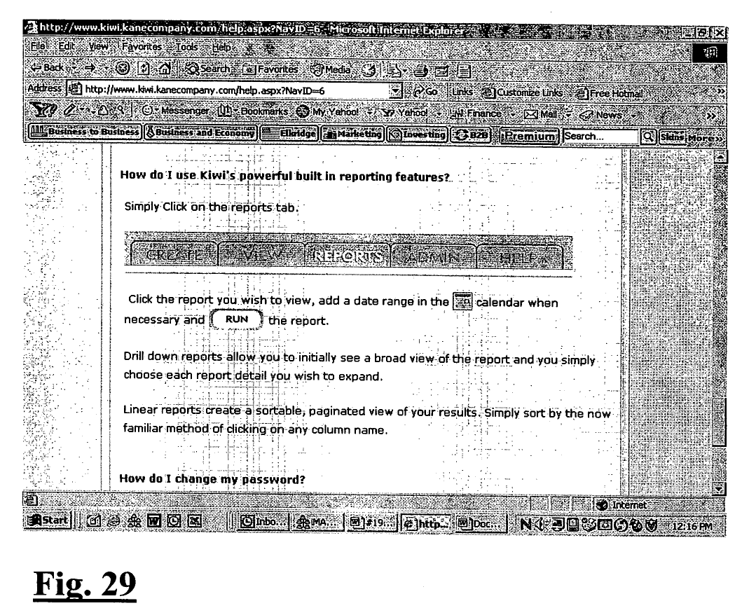

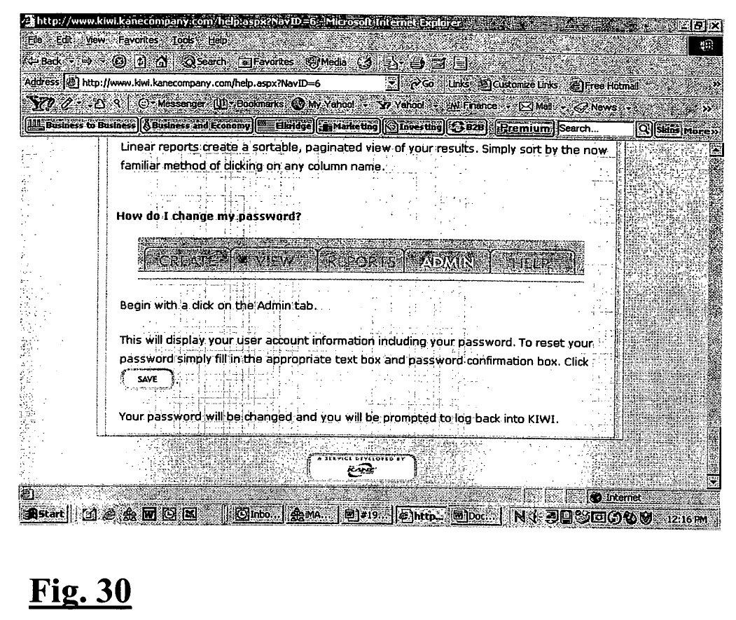

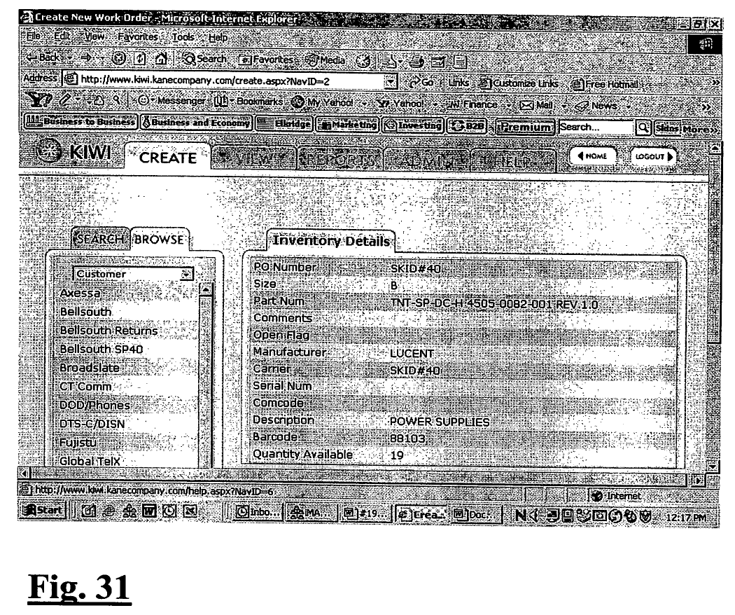

FIGS. 6-31 are exemplary GUI screens that a user might encounter in performing the methods of FIGS. 4a-4e.

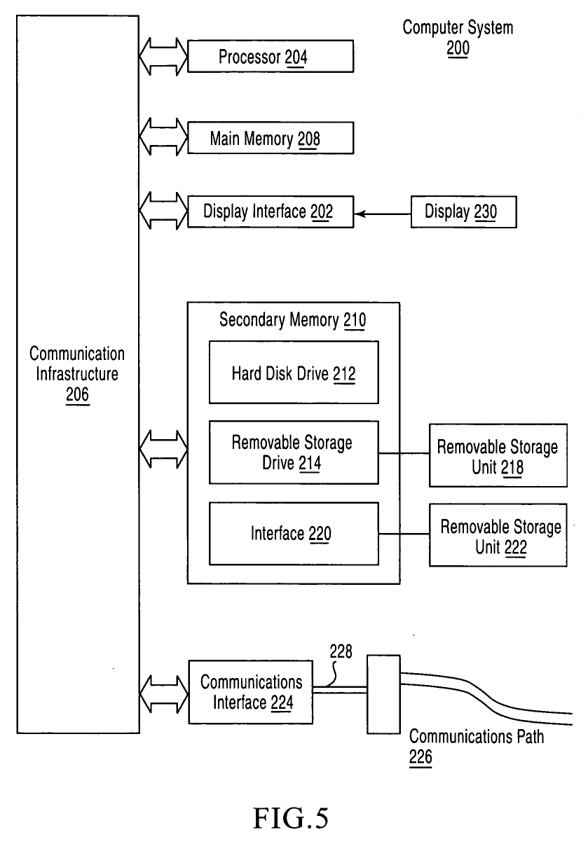

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 5.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Example embodiments of the present invention have now been described in accordance with the above advantages. It will be appreciated that these examples are merely illustrative of the invention. Many variations and modifications will be apparent to those skilled in the art.

1. A method for electronically tracking inventory, comprising:
receiving identifying information specifying an inventory item;
identifying at least one inventory listing associated with the inventory item;
identifying at least one responsible party associated with the inventory item; and
storing the identifying information in a data repository.
